(19) United States
(12) Patent Application Publication
(10) Pub. No.: US 2010/0178955 A1
(43) Pub. Date: Jul. 15, 2010

(54) MOBILE DEVICE COMPRISING A NAVIGATION DEVICE

(75) Inventors: Andrew Strawn, Hants (GB); Gregory Steeves, Hants (GB); Andrew Bick, Dorset (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/519,840

(22) PCT Filed: Dec. 20, 2006
(86) PCT No.: PCT/EP2006/012289

§ 371 Date: Feb. 24, 2010

(51) Int. Cl. H04M 1/00; H04B 1/38

(52) U.S. Cl. 455/556.1; 455/566; 455/575.1

(57) ABSTRACT

A mobile device (1) has a housing with an operating face (13) and at least one other surface area. The operating face includes a display screen and a keypad. The user interface further includes a navigational device. The navigational device (10) is placed in said other surface area of the housing of the mobile device and can be placed at an edge or a corner of the housing of the mobile device.

### FIELD OF THE INVENTION

The present invention relates to mobile devices that have a user interface that includes a display screen, a keypad and a navigational device.

### BACKGROUND OF THE INVENTION

In a popular conventional solution the operating face of mobile phones includes a display screen with softkeys there below and a navigation key or joystick centrally placed between the soft keys. An alphanumeric keypad is placed below the softkeys. The navigation key or joystick is intended to be used in combination with the other keys.

One of the challenges in mobile phone user interface design is to provide a user interface that is intuitive, easy to learn, behaves in a consistent, predictable manner and makes the best use of limited operation face surface area. A user interface needs to provide a sufficient number of controls to manage the inherent complexity of the mobile phone whilst ensuring that there are not too many controls are options available to the user at any one time, thereby causing confusion. Thus, aspects of the invention aim to provide user interface that is better adapted to meet these needs.

The above also applies to other types of mobile devices, such as PDA's, music or multimedia players, cameras, etc.

In the current solution with a navigation device in centre users tend to use the navigation device in the centre as a shutter key for portrait mode and a second shutter key on an edge of the device for landscape mode. It is theoretically possible to use the central navigation device for taking pictures in landscape mode but in single handed operation in landscape mode with the central key as shutter key the user's fingers may obscure the lens, which is why users taking an image in landscape mode would tend to have their fingers positioned along the edge of the product, hence single handed landscape operation with a conventional layout is not optimal so users tend to use two hands.

### DISCLOSURE OF THE INVENTION

On this background, it is an object of the present invention to provide a mobile device with an improved user interface. This object is achieved by providing a mobile device comprising a housing with an operating face and at least one other surface area that is substantially perpendicular to the operating face, a display screen supported by the housing and disposed on the operating face, a keypad or a number of keys supported by the housing and disposed on the operating face, and a navigation device supported by the housing and disposed on the other surface area.

By placing the navigational device on another surface than the operating face, the operating face becomes less crowded and for various usage scenarios the navigation device can be activated in a more ergonomic and user friendly way.

The other surface area may include a corner or edge of the housing. By placing the navigational device on a corner or edge of the device, it becomes possible to hold the mobile device more firmly in security whilst operating the navigational device. This can particularly be useful when the mobile device is used for GPS navigation or for gaming.

The operating face can be an interrupted face formed by two or more continuous surfaces. This can be the case for devices with a folding or sliding housing.

Alternatively, the operating face can be an uninterrupted surface. This can be the case for so-called “candy bar” type mobile devices that have housing shaped like a cuboid, typically a rounded cuboid.

The mobile device may further comprise a processor connected to the display screen, to the keypad or number of keys and to the navigation device.

The navigation device may be countersunk and may be placed at an edge or corner of the housing.

The navigation device may be integrated into the surface of the housing.

The housing may have a shape that defines at least one edge or corner, and the navigation device can be positioned substantially at the at least one edge or corner.

The navigation device can be a joystick or a navigation key.

The housing can be substantially parallelepiped-shaped, with or without rounded corners and edges.

The mobile device may further comprise a second navigation device supported by the housing and disposed on the operating face.

The navigational device may have two operational axes and the operational axes may be substantially parallel to the other surface area.

Further objects, features, advantages and properties of the mobile device according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is a front view of a mobile device according to an embodiment of the invention,

FIG. 2 is an elevated rear view of the device of FIG. 1, with an enlarged section of a corner of the device,

FIG. 3 is the same view as FIG. 2 of another embodiment of the invention,

FIG. 4 is a block diagram illustrating the general architecture of a mobile device in accordance with the present invention,

FIG. 5 is a front view illustrating the use of the mobile device according to an embodiment of the invention in a portrait position, and

FIG. 6 is a front view illustrating the use of the mobile device according to an embodiment of the invention in a landscape position.

### DETAILED DESCRIPTION OF PREFERRED EMBODIMENTS

In the following detailed description, the mobile device according to the invention in the form of a personal computer, PDA, mobile terminal or a mobile communication terminal in the form of a cellular/mobile phone will be described by the preferred embodiments.

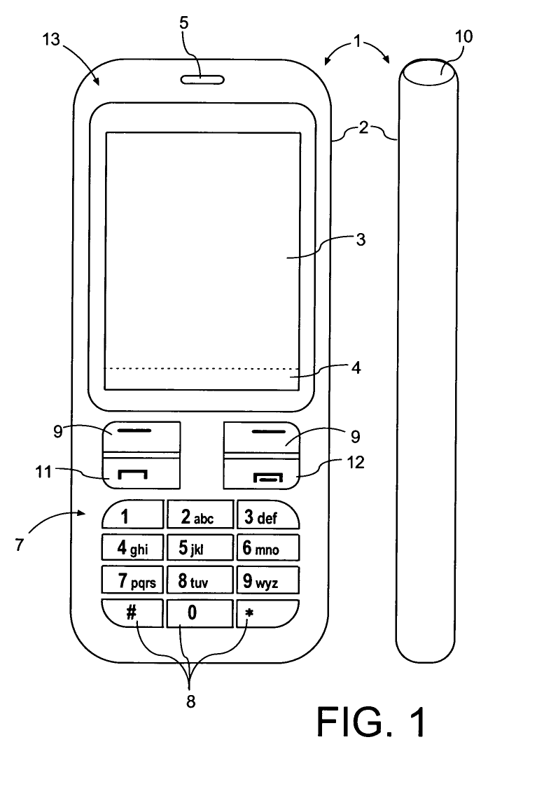

FIG. 1 illustrates a first embodiment of a mobile terminal according to the invention in the form of a mobile telephone by a front and side view. The mobile phone 1 comprises a user interface having a housing 2, a display screen 3, an on/off button (not shown), a speaker 5 (only the opening is shown), and a microphone 6 (not visible in FIG. 1). The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access). The housing 2 includes an operating face 13 formed by the front surface. The display screen 3 and a keypad 7 are carried by the housing 2 and disposed in the operating face 13.

The keypad 7 has a first group of keys 8 as alphanumeric keys, by means of which the user can enter a telephone number, write a text message (SMS), write a name (associated with the phone number), etc. Each of the twelve alphanumeric keys 8 is provided with a figure “0-9” or a sign “#” or “*”, respectively. In alpha mode each key is associated with a number of letters and special signs used in the text editing.

The keypad 2 has additionally a second group of keys comprising two softkeys 9, two call handling keys (offhook key 11 and onhook key 12). The function of the softkeys 9 depends on the state of the mobile phone 1.

The mobile device 1 includes a navigation device in the form of a 5-way navigation key 10 (up, down, left, right and center: select/activate) positioned at a corer of the housing 2. The navigation device 10 is placed on a surface of the mobile device 1 that is substantially at right angles with the operating face 13. The surface on which the navigation device 10 is placed can according to an embodiment be an edge or a corner of the mobile device. According to an embodiment the navigational device has two operational axes that are substantially parallel to the other surface area.

Navigation in the menu is performed by using the navigation-key 10. The present function of the softkeys 9 is shown in separate fields (soft labels) in a dedicated area 4 of the display 3, just above the softkeys 9. The two call handling keys 11,12 are used for establishing a call or a conference call, terminating a call or rejecting an incoming call.

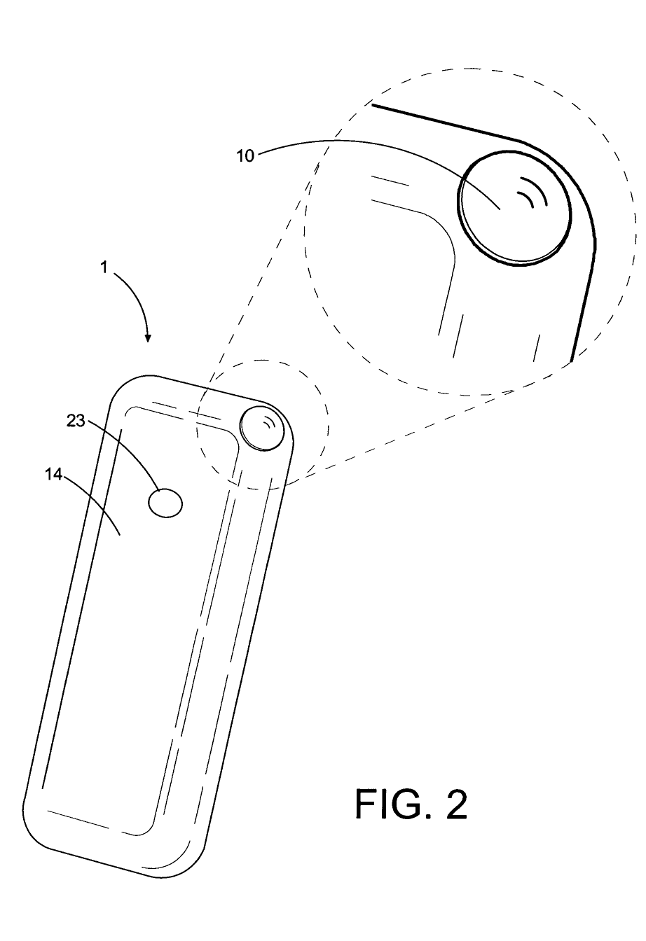

FIG. 2 illustrates the mobile phone 1 of the embodiment of FIG. 1 with an elevated rear view and in greater detail. The navigation key 10 is four- or five-way which can be used for cursor movement, scrolling and selecting (five-way key) and placed at a corner of the housing 2. According to an embodiment, the navigation key 10 is concave, similar to a small bowl. The navigation key 10 is according to an embodiment countersunk and substantially flush with the surrounding surface of the housing 2. Thereby, the navigation device 10 is integrated into the surface of the housing 2.

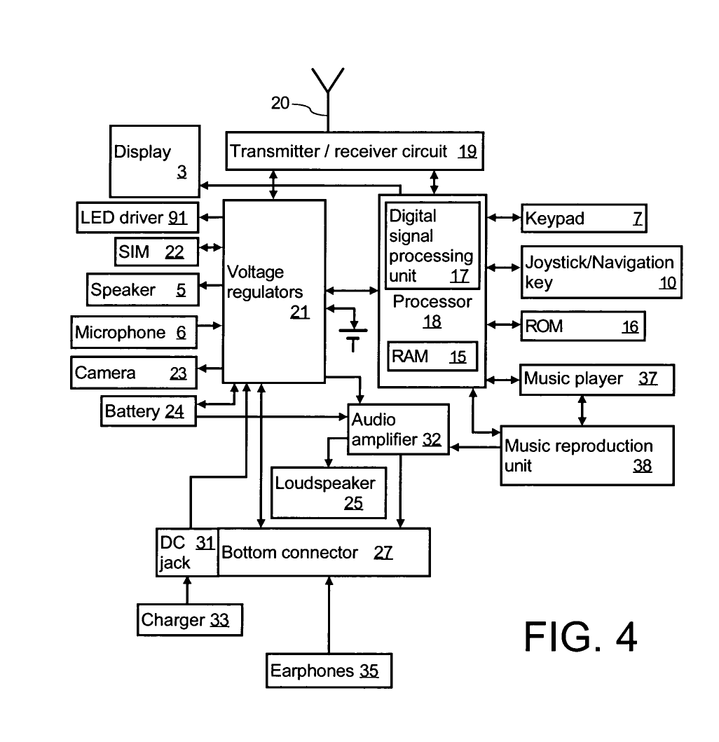

A releasable rear cover 14 gives access to the SIM card, and the battery pack 24 (FIG. 4) in the back of the phone that supplies electrical power for the electronic components of the mobile phone 1. The rear cover 14 is provided with an opening for a digital camera (lens) 23.

The mobile phone 1 has a flat display screen 3 that is typically made of an LCD with optional back lighting, such as a TFT matrix capable of displaying color images. A touch screen may be used on top of a conventional LCD display.

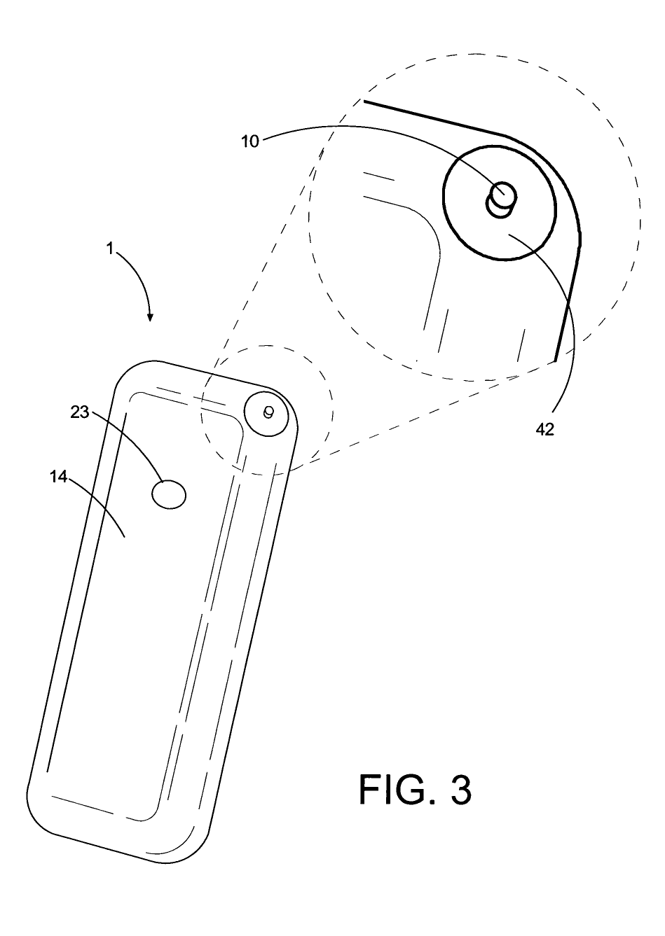

FIG. 3 illustrates another embodiment of the invention that is essentially identical with the embodiment described above, except for the construction of the navigational device 10. The navigational device 10 is again placed on the corner of the housing 2, however, the navigation device is a joystick 10. In this embodiment the joystick is countersunk with the base of the joystick 10 placed in a concave recess 42.

FIG. 4 illustrates in block diagram form the general architecture of the mobile phone 1 constructed in accordance with the present invention. The processor 18 controls the operation of the terminal and has an integrated digital signal processor 17 and an integrated RAM 15. The processor 18 controls the communication with the cellular network via the transmitter/receiver circuit 19 and an internal antenna 20. A microphone 6 coupled to the processor 18 via voltage regulators 21 transforms the user's speech into analogue signals, the analogue signals formed thereby are A/D converted in an A/D converter (not shown) before the speech is encoded in the DSP 17 that is included in the processor 18. The encoded speech signal is transferred to the processor 18, which e.g. supports the GSM terminal software. The digital signal-processing unit 17 speech-decodes the signal, which is transferred from the processor 18 to the speaker 5 via a D/A converter (not shown).

The voltage regulators 21 form the interface for the speaker 5, the microphone 6, the LED drivers 91 (for the LEDS backlighting the keypad 7 and the display 3), the SIM card 22, the digital camera 23, battery 24, the bottom connector 27, the DC jack 31 (for connecting to the charger 33) and the audio amplifier 32 that drives the (hands-free) loudspeaker 25.

The processor 18 also forms the interface for some of the peripheral units of the device, including a (Flash) ROM memory 16, the graphical display 3, the keypad 7, the navigation device 10, a music player 37 and a music reproduction unit 38.

The music player 37 can be a multimedia player that can play media with another format than music, such as for example video data. The music player 37 is part of the software on the mobile phone and provides a user interface for selecting, playing, pausing, stopping, forwarding, rewinding, and handling songs.

The music reproduction unit 38 is part of the software of the mobile phone and is operable to reproduce music data that is stored in one of the memories or recording media of the mobile phone 1.

The reproduced music is routed to the earphones 35 when earphones are connected to the bottom connector 27 else, the reproduced music is routed to the loudspeaker 25. Depending on user settings, ringing tones may be routed to the loudspeaker 25 even if earphones 35 are connected to the bottom connector 27.

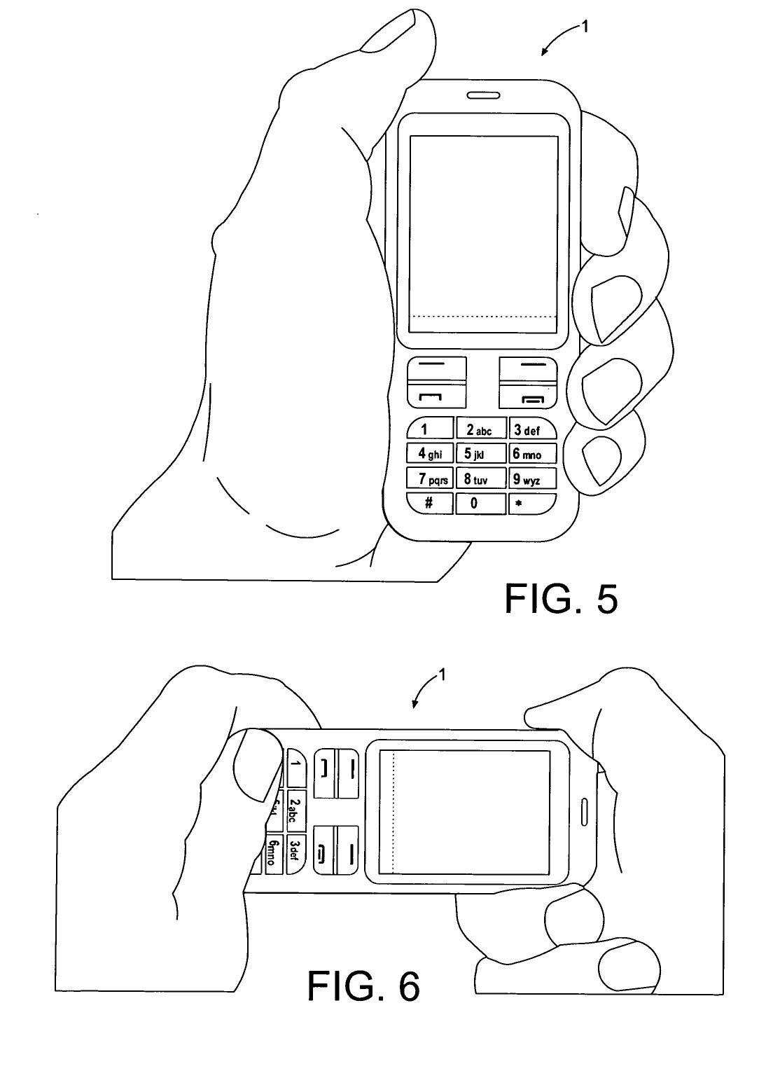

In operation the navigational device 10 can be very well accessed when the mobile phone is either held in the upright (portrait) position as shown in FIG. 5 or in the horizontal (landscape) position as shown in FIG. 6.

The ergonomics and usage of the joystick/navigation device 10 are improved depending on the implementation of the joystick/navigation key 10 in the mobile device 1.

In the portrait mode, the user can for example navigate a map with the navigation device 10 whilst walking and allowing a stronger grip of the device while holding it than in a conventional layout with a central joystick/navigation key, in particular for single handed operation.

In the landscape mode the user can control the navigation device 10 with the one hand and operate some of the keys of the keypad 7 with the other hand. Thus, two-handed gaming is more comfortable and ergonomic than in a conventional layout with a central joystick/navigation key.

According to an embodiment (not shown) that is essentially identical to the embodiments above, the mobile apparatus 1 also includes a conventional central navigation device in the operating face together with the keypad and the display screen. With this embodiment a user can in the portrait position use the central navigation device for taking pictures and in the landscape position the user can do the same with the navigation device at the corner.

The positioning of the navigation device on an edge or corner provides an advantageous single handed solution for both portrait and landscape modes of operation.

In the above embodiments the navigation device 10 is optimally placed for left-handed use, but it is understood that the navigation device can be placed on the opposite top corner for right-handed use.

According to an embodiment (not shown) the navigational device is placed on an edge of the housing of the mobile device, i.e. not at a corner.

The embodiments above illustrate the invention implemented in a device with a substantially parallelepiped-shaped housing with rounded corners and edges with an operating face that is formed by a single continuous surface of the housing. In other embodiments (not shown), the invention is implemented in fold or slide device that have a non-continuous operating face that is formed by two or more single surfaces.

The invention has numerous advantages. Different embodiments or implementations may yield one or more of the following advantages. It should be noted that this is not an exhaustive list and there may be other advantages which are not described herein. One advantage of the invention is that it allows for a more appropriate input device for various tasks. Another advantage of the invention is that it provides for a better holding position for some UI modes. Yet another advantage of the invention is that it provides for improved one-handed use, i.e. walking whilst looking at the display screen. Another advantage of the invention is that the navigation device can be positioned on the edge of the housing of the device, i.e. in a corner. This can then be integrated into the product surfaces. Another advantage of the invention is that a separate analog and digital joystick are possible on one and the same device. It is another advantage of the invention that it provides an alternative UI arrangement for single handed operation.

The positioning of the navigation device on the corner provides an alternative arrangement which is advantageous over the current positioning because mobile devices now take on multiple functionality, i.e. camera and radio handset. This means that the user may wish to use the product in more than one orientation (camera in landscape and phone in portrait). The present invention provides for a handset that can be operated in accordance with these user wishes.

The term “comprising” as used in the claims does not exclude other elements or steps. The term “a” or “an” as used in the claims does not exclude a plurality. The single processor or other unit may fulfill the functions of several means recited in the claims.

Although the present invention has been described in detail for purpose of illustration, it is understood that such detail is solely for that purpose, and variations can be made therein by those skilled in the art without departing from the scope of the invention.

1. A mobile device comprising:
a housing having an operating face and at least one other surface area that is substantially perpendicular to the operating face,
a display screen supported by said housing and disposed on said operating face,
at least one key supported by said housing and disposed on said operating face, and
a navigation device supported by said housing and disposed on said other surface area.

2. A mobile device according to claim 1, wherein said other surface area includes a corner or edge of said housing.

3. A mobile device according to claim 1, wherein said operating face is an interrupted surface formed by two or more continuous surfaces.

4. A mobile device according to claim 1, wherein said operating face is a continuous surface.

5. A mobile device according to claim 1, further comprising a processor connected to said display screen, to said at least one key and to said navigation device.

6. A mobile device according to claim 1, wherein said navigation device is countersunk in an edge or corner of said housing.

7. A mobile device according to claim 1, wherein said navigation device is integrated into a the surface of said housing.

8. A mobile device according to claim 1, wherein said housing has a shape that defines at least one edge or corner, and wherein said navigation device is positioned substantially at said at least one edge or corner.

9. A mobile device according to claim 1, wherein said navigation device is a joystick or a navigation key.

10. A mobile device according to claim 1, wherein said housing is substantially parallelepiped-shaped, with or without rounded corners and edges.

11. A mobile device according to claim 1, further comprising a second navigation device supported by said housing and disposed on said operating face.

12. A mobile device according to claim 1, wherein said navigational device has two operational axes.

13. A mobile device according to claim 1, wherein said the operational axes are substantially parallel to said other surface area.
